(19) United States
(12) Patent Application Publication
(10) Pub. No.: US 2008/0184707 A1
(43) Pub. Date: Aug. 7, 2008

(54) Fuel manifold for combustion systems

(75) Inventors: Frank J. Zupanc, Phoenix, AZ (US); Ian L. Critchley, Phoenix, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/588,893

(22) Filed: Oct. 27, 2006

(51) Int. Cl. F02C 1/00

(52) U.S. Cl. 60/745; 431/168; 123/467

(57) ABSTRACT

A fuel manifold is provided for receiving a flow of fuel from a fuel source and delivering the flow of fuel to a rotary fuel slinger. The fuel manifold can include a housing having an end face and defining a cavity for receiving the flow of fuel; at least one exit orifice formed in the housing end face and in fluid communication with the cavity; and a fuel drip guide extending from the end face.

### FIELD OF THE INVENTION

The present invention generally relates to fuel manifolds for combustion systems, and more particularly relates to fuel manifolds for manifold-fed slinger gas turbine combustors with a fuel drip guide.

### BACKGROUND OF THE INVENTION

Combustion systems in gas turbine engines typically ignite and combust an air/fuel mixture to drive a turbine. The combustion system can include a fuel manifold that supplies a stream of fuel to a rotary fuel slinger that atomizes the fuel. The atomized fuel is then mixed with air in the combustion chamber and ignited by an igniter. The efficiency of atomization impacts the efficiency of the combustion system and the engine overall. Typically, the exit orifices of the fuel manifold are sized to maintain distinct, cleanly separated fuel jets to the rotary fuel slinger, even at low fuel flow rates such as those that might occur during ignition. Given the wide turn-down ratio of modern gas turbine engines, however, the sizing of the fuel manifold orifices for ignition may result in a relatively high pressure differential under maximum power conditions. This can result in the need for a more expensive high-pressure fuel delivery system, and may also result in the tendency for the high-velocity fuel jets to break-up and splatter, either before or upon making contact with the slinger. Without the high-pressure fuel delivery system, low flow conditions can result in the fuel dribbling out of the fuel manifold and not reaching the slinger. Either condition can adversely impact the effectiveness of the slinger and result in fuel contamination in the area surrounding the fuel manifold.

Accordingly, it is desirable to provide an improved combustion system. In addition, it is desirable to provide a fuel manifold for a combustion system that can provide fuel to the slinger to be atomized during any operating condition and without a high-pressure fuel delivery system. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A combustion system can include a fuel manifold adapted to receive a flow of fuel from a fuel source. The fuel manifold can include at least one exit orifice from which the received fuel is discharged. The system can further include a rotary fuel slinger disposed adjacent to, and adapted to receive the flow of fuel from, the fuel manifold and to atomize the received fuel, and a combustor including at least a forward radial liner and an aft radial liner spaced apart from one another to form a combustion chamber therebetween that receives the atomized fuel from the rotary fuel slinger. The forward and aft radial liners can each include a plurality of openings for receiving compressed air into the combustion chamber to mix with the atomized fuel. The system can further include an igniter extending at least partially into the combustion chamber and configured to ignite the atomized fuel and the compressed air mixture; and a fuel drip guide disposed adjacent the fuel manifold exit orifice.

A fuel manifold is provided for receiving a flow of fuel from a fuel source and delivering the flow of fuel to a rotary fuel slinger. The fuel manifold can include a housing having an end face and defining a cavity for receiving the flow of fuel; at least one exit orifice formed in the housing end face and in fluid communication with the cavity; and a fuel drip guide extending from the end face.

A method is provided for delivering a flow of fuel to a rotary fuel slinger from a fuel manifold having at least one exit orifice and a fuel drip guide. The method includes, during normal operating conditions, providing the flow of fuel directly from the at least one exit orifice to the rotary fuel slinger; and during low flow operating conditions, directing the flow of fuel from the at least one exit orifice to the rotary fuel slinger via the fuel drip guide.

### BRIEF DESCRIPTION OF THE DRAWINGS

The present invention will hereinafter be described in conjunction with the following drawing figures, wherein like numerals denote like elements, and

FIG. 1 is a cross sectional view of a combustion system in accordance with an exemplary embodiment of the present invention under normal operating conditions; and

FIG. 2 is a close-up view of a portion of the combustion system of FIG. 1 under normal operating conditions; and

FIG. 3 is a close-up view of a portion of the combustion system of FIG. 1 under low fuel flow operating conditions.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

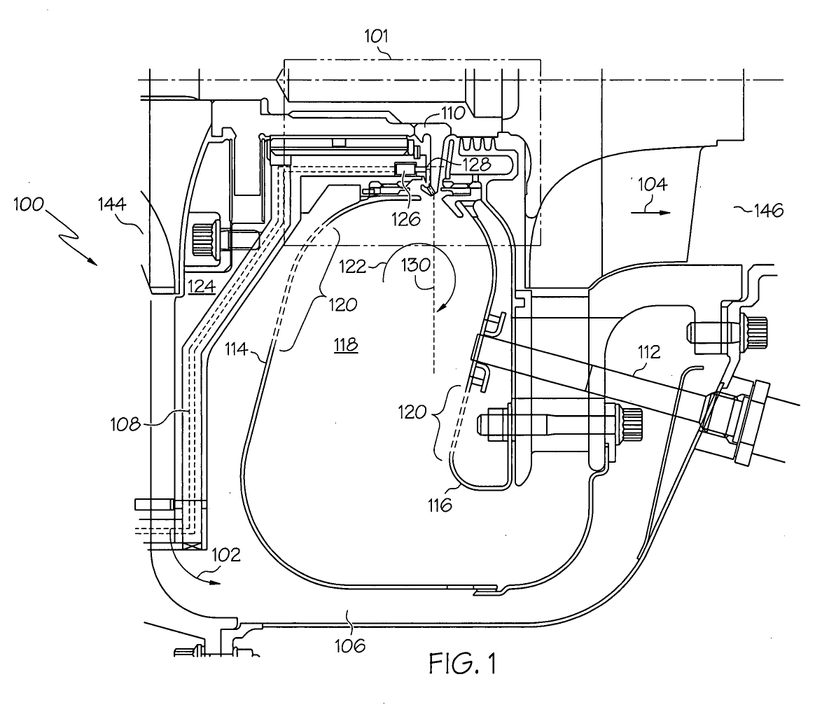

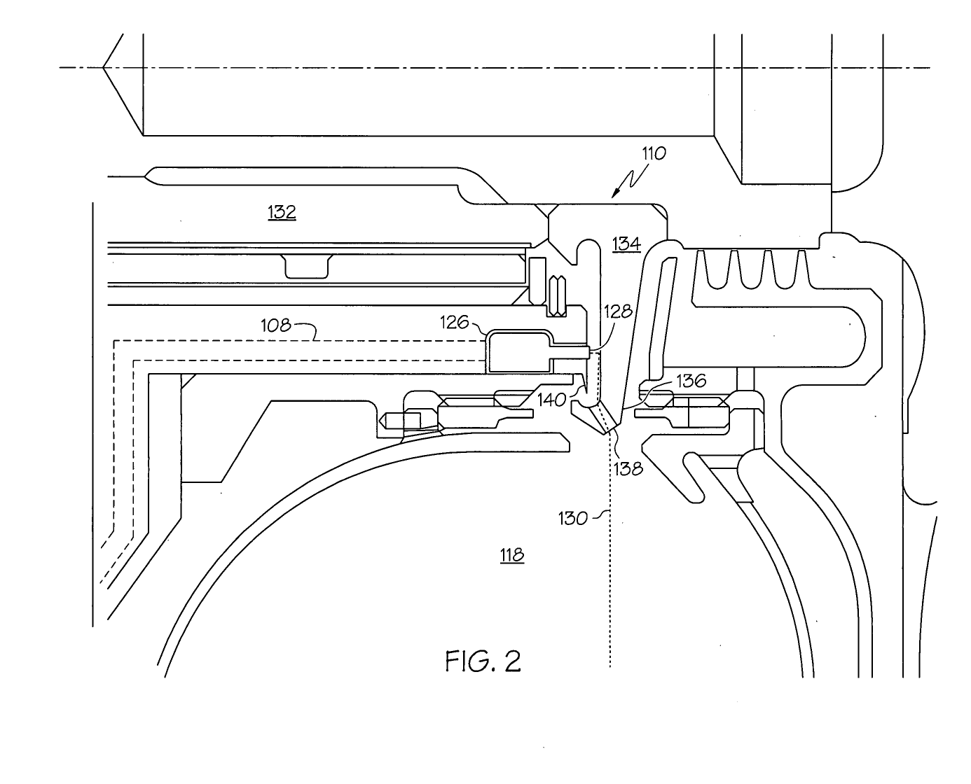

FIG. 1 illustrates a cross sectional view of a combustion system 100, and FIG. 2 illustrates a close-up view of a portion of the combustion system 100 indicated by box 101. FIGS. 1 and 2 illustrate the combustion system 100 under normal fuel flow operating conditions. The combustion system 100 receives compressed air 102 from a partially shown compressor 144, where it is mixed with a fuel supplied from a fuel source (not shown). In the combustion system 100, the fuel/air mixture is combusted to generate high-energy gas 104. The high-energy gas 104 is then diluted and supplied to the turbine 146. The high-energy, diluted gas 104 from the combustion system 100 expands through the turbine, where it gives up much of its energy and causes the turbine 146 to rotate. As the turbine 146 rotates, it drives various types of equipment that may be mounted in, or coupled to, the engine (not shown).

The combustion system 100 includes a combustor 106, a fuel supply tube 108, a rotary fuel slinger 110, and an igniter 112. The combustor 106 can be a radial-annular combustor, and include a forward annular liner 114, and an aft annular liner 116. The forward and aft annular liners 114, 116 are spaced apart from one another and form a combustion chamber 118. The forward and aft annular liners 114, 116 each include a plurality of air inlet orifices 120, and a plurality of effusion cooling holes (not shown). As noted above, compressed air 102 from the compressor flows into the combustion chamber 118 via the air inlet orifices 120 in both the forward and aft annular liners 114, 116. The air inlet orifices 120 can be configured to generate a single toroidal recirculation flow pattern 122 in the combustion chamber 118.

The fuel supply tube 108 extends into a plenum 124 just forward of the combustor 106 and is adapted to receive a flow of fuel from the fuel source, for example, via diffuser vanes (not shown). The fuel supplied to the fuel supply tube 108 passes through the tube 108, and is directed into a fuel manifold 126. In the depicted embodiment, the fuel manifold 126 has a housing defining a circumferential cavity, although it will be appreciated that other configurations could also be used. The fuel manifold 126 includes an end face with a plurality of equally spaced orifices 128 formed therein, through which the fuel is delivered to the rotary fuel slinger 110. In an exemplary embodiment, the fuel supply tube 108 only supplies liquid fuel to the fuel manifold 126.

The rotary fuel slinger 110, which is shown more clearly in FIG. 2, includes a coupler shaft 132, a vertical shoulder 134, and a slinger 136. The coupler shaft 132 can be coupled to the turbine shaft (not shown) and rotate therewith. The vertical shoulder 134 can be coupled to the coupler shaft 132 and thus rotate with the coupler shaft 132. The fuel exits through the orifices 128 in the fuel manifold 126 and impinges onto the vertical shoulder 134. Because the vertical shoulder 134 rotates with the coupler shaft 132, the impinging fuel acquires the tangential velocity of the coupler shaft 132 and is centrifuged into the slinger 136.

The slinger 136 is coupled to, and can be formed as an integral part of, the vertical shoulder 134 and thus also rotates with the coupler shaft 132. In the depicted embodiment, the slinger 136 has a substantially cup-shaped radial cross section, and includes a plurality of relatively small, equally spaced holes or slots 138. As the slinger 136 rotates, fuel is centrifuged through these holes 138 and atomized into tiny droplets to distribute the fuel into the combustion chamber 118. The distributed fuel droplets are readily evaporated and ignited in the combustion chamber 118.

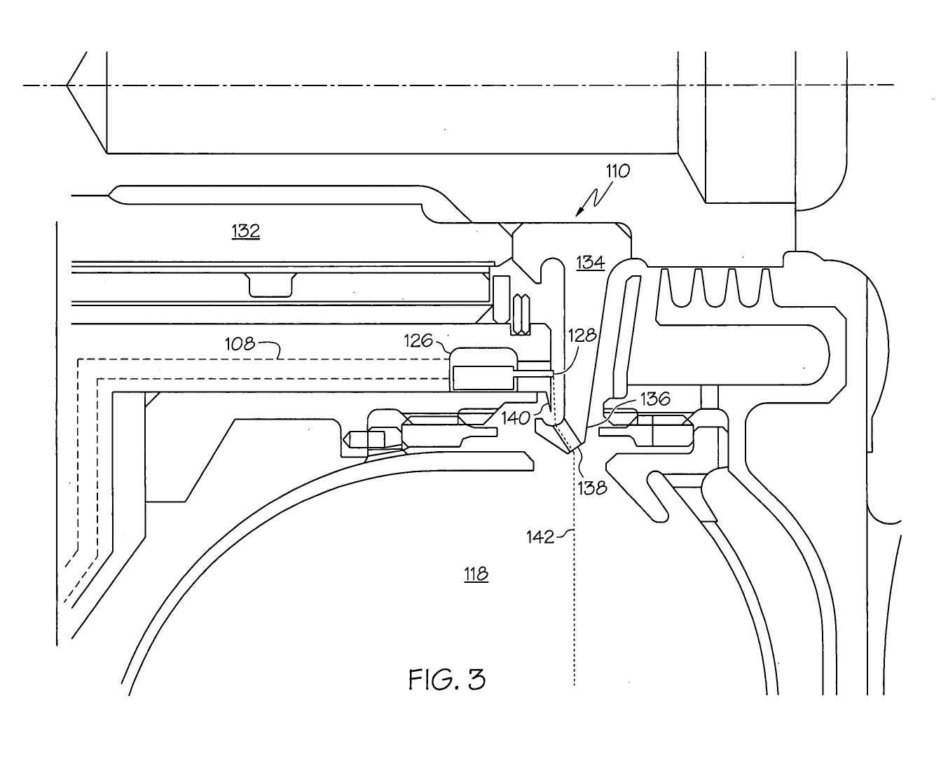

During most operating conditions, the fuel separates from the fuel manifold 126 at the orifices 128 and streams directly onto the rotary fuel slinger 110, as shown in FIGS. 1 and 2 by fuel path 130. Accordingly, in one embodiment, the primary path for delivering the flow of fuel to the rotary fuel slinger 110 is directly from the orifices 128. Referring to FIG. 3, however, during some operating conditions, such as during ignition, a low flow of fuel in the fuel manifold 126 results in the fuel not having sufficient pressure or force to separate from the fuel manifold 126 at the orifices 128. As shown in FIG. 3 by fuel path 142, a fuel drip guide 140 can be provided on the end of the fuel manifold 126, to guide fuel from the orifices 128 onto the rotary fuel slinger 110. In an exemplary embodiment, the fuel drip guide 140 is a knife-edge drip guide and extends around the circumference of the fuel manifold 126. The fuel drip guide 140 extends to a length sufficient such that the fuel traveling down the fuel drip guide 140 will be directed to the rotary fuel slinger 110. In an exemplary embodiment, the length of the fuel drip guide 140 is, for example, 0.050 to 0.080 inches, although the length of the fuel drip guide 140 can depend on the size of the combustion system 100 and can be adjusted as necessary. In an exemplary embodiment, the fuel drip guide 140 is parallel to the end face of the fuel manifold 126. In alternate embodiments, the fuel drip guide 140 can be at an angle relative to the end face of the fuel manifold. Generally, the fuel adheres to the fuel manifold 126 and then the fuel drip guide 140 as a result of surface tension. Gravity then pulls the fuel down the fuel drip guide 140 until the force of gravity overcomes the surface tension, and the fuel drips off the fuel drip guide 140 onto the rotary fuel slinger 110.

In an exemplary embodiment, the fuel drip guide 140 is only utilized during low flow conditions, for example, during ignition. In the absence of the fuel drip guide 140, fuel can adhere to the side and bottom portions of the fuel manifold 126. This can result in the fuel not reaching the rotary fuel slinger 110 and not being atomized, which in turn results in the un-atomized fuel contaminating portions of the combustor system and reducing the efficiency and performance of the engine, particularly at ignition.

The fuel drip guide 140 provides a mechanism for ensuring a controlled fuel delivery from the fuel manifold 126 to the rotary fuel slinger 110, particularly at low fuel flow rates associated with ignition conditions. Particularly, the fuel drip guide 140 can provide fuel delivery to the fuel manifold 126 when the fuel flow rates are such that the pressure differential across the fuel manifold 126 is insufficient for the fuel to separate from the fuel manifold 126, for example at less that 0.5 psid. Even at high flow or normal operating conditions, the fuel drip guide 140 can direct any fuel that is splattered out of the fuel jet as a result of sputtering. One embodiment of the present invention can extend the effective turn-down ratio of the combustion system 100 without requiring a high-pressure fuel delivery system. The combustion system 100 can be utilized in, for example, an auxiliary power unit or a propulsion gas turbine engine.

The igniter 112 extends through the aft annular liner 116 and partially into the combustion chamber 118. The igniter 112, which may be any one of numerous types of igniters, is adapted to receive energy from an exciter (not shown) in response to the exciter receiving an ignition command from an external source, such as an engine controller (not shown). In response to the ignition command, the igniter 112 generates a spark of suitable energy, which ignites the fuel-air mixture in the combustion chamber 118, and generates the high-energy combusted gas that is supplied to the turbine.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without-departing from the scope of the invention as set forth in the appended claims.

1. A combustion system, comprising;
a fuel manifold adapted to receive a flow of fuel from a fuel source, the fuel manifold including at least one exit orifice from which the received fuel is discharged;
a rotary fuel slinger disposed adjacent to, and adapted to receive the flow of fuel from, the fuel manifold and to atomize the received fuel;
a combustor including at least a forward radial liner and an aft radial liner spaced apart from one another to form a combustion chamber therebetween that receives the atomized fuel from the rotary fuel slinger, the forward and aft radial liners each including a plurality of openings for receiving compressed air into the combustion chamber to mix with the atomized fuel;
an igniter extending at least partially into the combustion chamber and configured to ignite the atomized fuel and the compressed air mixture; and
a fuel drip guide disposed adjacent the fuel manifold exit orifice.

2. The combustion system of claim 1, wherein the fuel manifold is configured such that,
during normal operating conditions, the flow of fuel exits the at least one exit orifice and flows directly onto the rotary fuel slinger, and
during low flow operating conditions, the flow of fuel exits the at least one exit orifice, flows down the fuel drip guide, and onto the rotary fuel slinger.

3. The combustion system of claim 1, wherein a rotary fuel slinger includes
a coupler shaft adapted to receive a rotational drive force,
a vertical shoulder extending substantially perpendicular from the coupler shaft, and
a slinger extending substantially perpendicular from the vertical shoulder and including a plurality of evenly spaced openings extending therethrough,
wherein the rotary fuel slinger is adapted to receive the flow of fuel from the fuel manifold and, upon receipt of the rotational drive force, to centrifuge the received fuel into the combustion chamber to atomize the fuel.

4. The combustion system of claim 1, wherein the rotary fuel slinger has a substantially cup-shaped radial cross section.

5. The combustion system of claim 1, wherein the fuel drip guide has a length of about 0.05 to about 0.08 inches.

6. The combustion system of claim 1, wherein the fuel manifold includes an end face, the fuel drip guide is parallel to the end face, and the fuel drip guide having a first side that, during low flow operating conditions, directs the flow of fuel onto the rotary fuel slinger and a second side that does not contact fuel.

7. The combustion system of claim 1, wherein the fuel manifold has an annular shape with a circumference, and the drip guide extends around the circumference of the fuel manifold.

8. The combustion system of claim 1, wherein the fuel drip guide is a knife-edge guide.

9. The combustion system of claim 1, wherein the rotary fuel slinger primarily receives the flow of fuel directly from the at least one exit orifice.

10. A fuel manifold for receiving a flow of fuel from a fuel source and delivering the flow of fuel to a rotary fuel slinger, the fuel manifold comprising:
a housing having an end face and defining a cavity for receiving the flow of fuel;
at least one exit orifice formed in the housing end face and in fluid communication with the cavity; and
a fuel drip guide extending from the end face.

11. The fuel manifold of claim 10, wherein the fuel manifold is configured such that,
during normal operating conditions, the flow of fuel exits the at least one exit orifice and flows directly onto the rotary fuel slinger, and
during low flow operating conditions, the flow of fuel exits the at least one exit orifice, flows down the fuel drip guide, and onto the rotary fuel slinger.

12. The fuel manifold of claim 10, wherein the fuel drip guide has a length of about 0.05 to about 0.08 inches.

13. The fuel manifold of claim 10, wherein the fuel drip guide is parallel to the end face, the fuel drip guide having a first side that, during low flow operating conditions, directs the flow of fuel onto the rotary fuel slinger and a second side that does not contact fuel.

14. The fuel manifold of claim 10, wherein the end face has a circumferential shape and the drip guide extends around the circumference of the end face.

15. The fuel manifold of claim 10, wherein the fuel drip guide is a knife-edge guide.

16. The fuel manifold of claim 10, wherein the fuel manifold is configured to primarily deliver the flow of fuel directly from the at least one exit orifice.

17. A method of delivering a flow of fuel to a rotary fuel slinger from a fuel manifold having at least one exit orifice and a fuel drip guide, the method comprising:
during normal operating conditions, providing the flow of fuel directly from the at least one exit orifice to the rotary fuel slinger; and
during low flow operating conditions, directing the flow of fuel from the at least one exit orifice to the rotary fuel slinger via the fuel drip guide.

18. The method of claim 17, wherein the fuel drip guide has a length of about 0.05 to about 0.08 inches.

19. The method of claim 17, wherein the fuel manifold has a end face, and wherein the fuel drip guide is parallel to the end face, the fuel drip guide having a first side that, during low flow operating conditions, directs the flow of fuel onto the rotary fuel slinger and a second side that does not contact fuel.

20. The method of claim 17, wherein the fuel drip guide is a knife-edge guide.
